(19) United States
(12) Patent Application Publication
(10) Pub. No.: US 2010/0209685 A1
(43) Pub. Date: Aug. 19, 2010

(54) LOW-RADIATION COVER GLASS AND USE THEREOF

(75) Inventors: Andreas Weber, Wiesbaden (DE); Holger Wegener, Alfeld (DE); Reinhard Kassner, Delligsen (DE); Peter Brix, Mainz (DE)

Correspondence Address: BAKER & DANIELS LLP;111 E. WAYNE STREET, SUITE 800, FORT WAYNE, IN, 46802, US

(73) Assignee: Schott AG, Mainz (DE)

(21) Appl. No.: 12/092,337

(22) PCT Filed: Oct. 2, 2006
(86) PCT No.: PCT/EP06/09557

§ 371 Date: Oct. 20, 2008

(30) Foreign Application Priority Data
Nov. 3, 2005 (DE) 10 2005 052 420.6

(51) Int. Cl. C03C 3/091; C03C 3/093; C03C 3/089; C03C 3/085; C03C 3/083; C03C 3/078; C03C 3/076; C03C 4/00

(52) U.S. Cl. 428/220; 501/67; 501/66; 501/65; 501/69; 501/68; 501/72; 501/55

(57) ABSTRACT

The invention relates to a low-radiation cover glass for radiation-sensitive sensors, with low intrinsic α-radiation, in particular for use with semiconductor technology. The glass includes a glass composition, selected from the following: aluminosilicate glass, aluminoborosilicate glass, borosilicate glass, in particular borosilicate glass that is devoid of alkali, with a TiO2 content of >0.1-10% by weight, in particular 1-8% by weight.

The invention relates to low-radiation cover glass and its uses.

The housing of certain sensors on a semiconductor basis, such as CCD sensors, requires glass that has a particularly low radiation. An example of such a CCD sensor (charge-coupled device) is an integrated circuit for light detection, which is used in digital and video cameras, for example, and which represents a light-sensitive electronic component for the position-sensitive (fine raster) measurement of light intensity. CCDs include semiconductors and are thus a semiconductor detector.

For such sensors, the α radiation is determined to be particularly critical. The negative impact of radioactive radiation on CCD sensors is described, for example, in TECHNICAL No. TH-1087 and in JP 04-308669. For example, if glass contains traces of the radioactive elements uranium and thorium, their radiation, particularly their a radiation, will have a serious detrimental impact on the sensor covered by such glass.

Glass with a low intrinsic a radiation is known, where the state of the arts controls particularly the contamination of such glass with uranium and thorium to reduce it to the minimum level. Thus, for example, JP 04-308669 describes a video sensor with a color filter in a housing. The cover glass is designed here for the upper segment of the housing opposite the sensor. The glass has a total concentration of uranium and thorium of 30 ppb or less. Furthermore, JP 04-308669 asserts that iron and titanium are undesirable contamination with negative influences on the sensor, which must not exceed a total concentration of 30 to 100 ppm.

Uranium and thorium emit a radiation among others, but also β and γ radiation, as described, for example, in K. H. Lieser, Einführung in die Kernchemie, 1980, page 4. In order to produce glass with low additional intrinsic β and γ radiation, it was thus proposed that the glass should not contain potassium, because the elements potassium, uranium, and thorium are known to be radioactive sources in small to very small quantities in many minerals and rocks. Thus, it is recommended to use potassium-free glass, as described, for example, in JP 2000233939 or JP 2001185710.

Thus, JP 2000233939 describes cover glass, specifically borosilicate glass, with a K₂O content of less than 0.2% by mass. Elements emitting a radiation should be present at levels ≦100 ppb and the levels of Fe₂O₃, TiO₂, PbO and ZrO₂, which are difficult to separate from emitters of α radiation, such as uranium, thorium and radium, should be ≦100 ppm in glass. The α radiation emitted by glass should not exceed a value of 0.05 counts/cm² h.

Similarly, JP 2001185710 describes glass composed of borosilicate glass with uranium content ≦50 ppb, a thorium content ≦50 ppb, and which contains essentially no K₂O. β radiation is reduced to a value of less than 5×10⁻⁶ μCi/cm². It is also mentioned that there should be no content of ZrO₂ or BaO, if possible, in order to avoid additional stress from uranium or thorium, which are often present in association with the raw materials of such oxides.

As mentioned above, it is thus useful to utilize low-radiation raw materials in order to produce low-radiation glass. Such raw materials are characterized by a low content of uranium and thorium. To this end, care must be taken that the uranium and thorium content of the silicon dioxide, because this raw material normally makes up more than 50% by weight of the mixture.

Moreover, it has been shown that it is not sufficient to control the uranium and thorium content. Rather, the inventors were able to show that an appropriately low content of uranium and thorium is a necessary but not sufficient condition for low a radiation in glass. Thus, it was a surprise to show that glass with a content of uranium and thorium of less than 10 ppb in each case exhibited a significantly high a radiation of 0.2 counts per hour per cm². This radiation was generated by radium, a decay product of uranium and thorium. Even though it is feasible to separate out uranium and thorium by geophysical and geochemical processes, radium will remain in the original material. This process may also be handled by chemical processing by the producer, such that, as described above, the radium content should also be specified and controlled, in addition to the uranium and thorium content.

The present invention is this based on the objective of producing glass compounds that satisfy the desired requirements for low-radiation glass to a high degree. In contrast to the state of the arts, the glass should be subject to a minimum of restrictions regarding the composition and offer a wide range of possible variations.

The invention meets the objective described above for low-radiation cover glass for radiation-sensitive sensors, specifically in the semiconductor technology, with low intrinsic a radiation with a composition of glass that includes aluminosilicate glass, aluminoborosilicate glass, borosilicate glass, in particular borosilicate glass that is devoid of alkali, with a TiO₂ content in the range of >0.1 to 10% by weight, specifically 1-8% by weight. Surprisingly, the glass compositions of the invention have a content of TiO₂ that exceeds the upper limit known in the state of the arts of 100 ppm. In particular, in total contrast to the known state of the arts, even glass compositions with a high titanium content are of benefit. The titanium content is most advantageously in the range of 1.5 to 7% by weight, preferably in the range of 2 to 6% by weight, most advantageously in the range of 3 to 5% by weight.

For example, preference is given to the use of float glass containing alkali, such as borosilicate glass (such as Borofloat 33, Borofloat 40, BK 7, Duran, D 263 from Schott AG, Mainz) as well as glass devoid of alkali (such as AF 37, AF 45 from Schott AG, Mainz), aluminosilicate glass (such as Fiolax, Illax from Schott AG, Mainz), alkaline earth glass (such as B 270 from Schott AG, Mainz), Li₂O—Al₂O₃—SiO₂ float glass or uncolored float glass with an iron concentration less than 100 ppb.

The concepts “low radiation” or “with low intrinsic radiation” should be understood with regard to the present patent such that these materials emit a radiation only to such an extent that a sensor located within the immediate vicinity is not negatively impacted by it. Regarding a radiation, JP 2004238283, among others, demands a radiation intensity of <0.0015 counts/cm² h in order to classify glass as emitting sufficiently low a radiation. This value is simultaneously the detection threshold of the measurement device used there (LACOM-4000, detector area 4000 cm², manufacturer: Sumitomo).

Thus, the cover glass of the invention preferentially has an a radiation <0.0020 counts/cm² h, more preferably <0.0015 counts/cm² h, most preferably <0.0013 counts/cm² h. In some cases, the radiation intensity may be set at <0.0010 counts/cm² h. A more preferable embodiment selects the uranium and thorium content of the produced glass such that the radiation intensity is less than the listed values. The invention found, surprisingly, that the upper value listed for the state of the arts, such as JP 2002-198504, JP 2000-086281, or JP 2004-238283 may be exceeded by a uranium and thorium content of 5 ppb each, without exerting the expected significant negative impacts regarding a radiation. A lower threshold value of 20 ppb or less, preferably 15 ppb or less, most preferably 10 ppb or less is entirely sufficient for the desired applications. Without limitation, it is assumed that this derives from the fact that α radiation extends for no more than 20 μm in glass with a density of 2.51 g/cm³, for example. Thus, only the α rays present in the top 20 μm of the surface contribute to the α radiation at the surface of the sensor.

Thus, it is preferable to adjust not only the uranium content and thorium content to <20 ppb, preferably <15 ppb, and most preferably to <10 ppb, but also the radium content is adjusted preferably to <20 ppb, more preferably <15 ppb, and most preferably to <10 ppb.

If, in addition to a low intrinsic α radiation of the glass of the invention, it is desired that the β and γ radiation should also be low, this may be achieved by glass that is devoid of potassium. In this case, the potassium content of the glass as described as zero. It is particularly preferable that the cover glass is also essentially devoid of alkali, i.e. that it is devoid of alkali except for contamination introduced during processing. According to the invention, it is preferable to adjust the γ radiation of the composite glass to <2.00 Bq/g, preferably to <1.67 Bq/g. However, the β or γ radiation may be neglected normally for applications in radiation-sensitive sensors related to semiconductors in the invention and is thus essentially of no significance.

It is preferable to measure the values for the α and optional β or γ radiation for the separate input materials and more preferably to check it in the glass melt.

Examples of glass compositions for low radiation cover glass according to the invention with a high TiO₂ content are selected from among the following combinations (% by weight on an oxide base):

| | |
|---|---|
| SiO₂ | 60-70% by weight |
| Na₂O | 1-10% by weight |
| K₂O | 0-20% by weight, specifically >5 to 8% by weight |
| ZnO | 0-10% by weight |
| Al₂O₃ | 0-10% by weight |
| B₂O₃ | 0-10% by weight |
| TiO₂ | >0.1-10% by weight, specifically 1 to 8% by weight |
| Sb₂O₃ | 0-2% by weight |

Other glass compositions with a high TiO₂ content are selected from among the following combinations (% by weight on an oxide base):

| | |
|---|---|
| SiO₂ | 48-58% by weight |
| BaO | 10-30% by weight, specifically 20 to 30% by weight |
| B₂O₃ | 1-15% by weight |
| Al₂O₃ | 0-20% by weight |
| As₂O₃ | 0-5% by weight, specifically 0 to 2% by weight |
| SrO | 0-3% by weight |
| CaO | 0-5% by weight |

where 1 to 2% by weight of BaO are substituted by TiO₂. It is preferable that this glass composition should have a TiO₂ content of 0.1-10% by weight.

If BaO is used in a glass composition, care must be taken that no barium containing radium is used, which would increase the proportion of a radiation significantly.

Other glass compositions with a high TiO₂ content are selected from among the following combinations (% by weight on an oxide base):

| | |
|---|---|
| SiO₂ | 45-70% by weight, specifically 60 to 70% by weight |
| B₂O₃ | 1-20% by weight, specifically 10 to 15% by weight |
| Al₂O₃ | 0-20% by weight, specifically 5 to 10% by weight |
| Na₂O | 1-10% by weight, specifically 1 to 5% by weight |
| BaO | 1-10% by weight, specifically 5 to 10% by weight |
| ZnO | 1-5% by weight, specifically 1 to 2% by weight |
| As₂O₃ | 0-2% by weight, specifically 0.1 to 1% by weight |
| TiO₂ | 1-5% by weight, specifically 1 to 2% by weight |

In another advantageous aspect of the invention, the glass compositions of low-radiation cover glass listed above have a uranium and thorium content, where the α radiation has a radiation intensity of preferably <0.0020 counts/cm² h, more preferably <0.0015 counts/cm² h, most preferably <0.0013 counts/cm² h. As explained above, a lower limit for uranium and thorium of preferably 20 ppb, more preferably <15 ppb, most preferably <10 ppb would be sufficient, such that expensive cleaning processes may be avoided in order to reduce the thorium and uranium content significantly below the content of 10 ppb. In a particularly preferable embodiment, the radium content of the cover glass according to the invention is adjusted to <20 ppb, more preferably to <15 ppb and most preferably to <10 ppb. In this manner and despite the presence of titanium, it is feasible to produce glass compositions with suitable reduced intrinsic α radiation of preferably <0.0020 counts/cm² h, more preferably <0.0015 counts/cm² h, most preferably <0.0013 counts/cm² h.

It is also particularly advantageous that the content of rare earth elements is reduced to the extent possible. Thus, it is also advantageous that the following elements do not exceed the maximum values listed:

Neodymium 0.5 ppm, preferably 0.2-0.4 ppm

Gadolinium 0.5 ppm, preferably 0.1 ppm

Hafnium 0.5 ppm, preferably 0.3-0.4 ppm

Samarium 0.1 ppm

Thus, it is surprising that the glass with high TiO₂ content according to the invention is useable for the intended use regardless of the method of manufacture.

The state of the arts, represented, for example, by the documentations JP 2002-198504, JP 2001-185710, JP 2000-086281, does not describe glass containing titanium oxide. Rather, the presence of titanium oxide is to be avoided completely to the extent possible. However, titanium oxide is an important ingredient to increase particularly the alkali resistance of glass (Horst Scholze, Glas-Natur, Struktur and Eigenschaften, pp. 325-326, Springer Verlag 1988). However, in contrast to the disclosure in JP 2002233939, the present invention could show surprisingly that, even with the TiO₂ content listed above, it is still feasible to obtain glass with a content of uranium and thorium and radium of preferably <20 ppb each, more preferably <15 ppb, most preferably <10 ppb, thus producing glass with a radiation of preferably <0.0020 counts/cm² h, more preferably <0.0015 counts/cm² h, most preferably <0.0013 counts/cm² h.

According to the invention, the low-radiation cover glass may be produced preferably by a draw process, specifically a down-draw or an up-draw process, or a float process. However, according to the invention, it is also feasible to use other known processes from the state of the arts.

The invention also deals with the use of the low-radiation and high-titanium cover glass in the area of semiconductor technology, specifically for radiation-sensitive sensors.

The advantages of the present invention are extraordinarily varied.

The insight of the invention presents the first means of producing glass that satisfies the demands imposed on low-radiation glass for radiation-sensitive sensors in the area of semiconductor technology, even though such glass contains titanium. Surprisingly and in contrast to the state of the arts, even glass compositions with a high content of titanium may be advantageous. Thus, glass with high TiO₂ content as per the invention may be useable unexpectedly for the intended use, regardless of the production method and the low-radiation composition of the glass.

The following examples of embodiments serve to illustrate the idea of the invention. They should be understood to be merely possible approaches presented as examples, which are not intended to limit the invention to their contents.

### EXAMPLES OF EMBODIMENTS

The invention is described in the following by way of examples of embodiments.

The down-draw process was used to produce glass according to the invention with the following composition, where the width of the flat glass was 430 mm in each case. The thickness of the glass varied between 0.3 and 0.8 mm.

Glass Composition I:

| | | |
|---|---|---|
| SiO₂ | 64.8% | by weight |
| Na₂O | 6.25% | by weight |
| K₂O | 6.7% | by weight |
| ZnO | 5.6% | by weight |
| Al₂O₃ | 4.2% | by weight |
| B₂O₃ | 7.9% | by weight |
| TiO₂ | 4.0% | by weight |
| Sb₂O₃ | 0.55% | by weight |
| sum | 100% | by weight |

Glass Composition II:

| | | |
|---|---|---|
| SiO₂ | 50.3% | by weight |
| BaO | 20.0% | by weight |
| B₂O₃ | 12.7% | by weight |
| TiO₂ | 4.7% | by weight |
| Al₂O₃ | 11.3% | by weight |
| As₂O₃ | 0.7% | by weight |
| SrO | 0.20% | by weight |
| CaO | 0.1% | by weight |
| sum | 100% | by weight |

Glass Composition III:

| | | |
|---|---|---|
| SiO₂ | 65% | by weight |
| B₂O₃ | 11.5% | by weight |
| Al₂O₃ | 5.0% | by weight |
| Na₂O | 5.7% | by weight |
| BaO | 6.5% | by weight |
| ZnO | 4.5% | by weight |
| As₂O₃ | 0.2% | by weight |
| TiO₂ | 1.6% | by weight |
| sum | 100% | by weight |

The cover glass produced in accordance with the invention was low-radiation, where the content of uranium, thorium and radium was in each case in the vicinity of 10 ppb. The measurement for α radiation indicated a value of <0.0013 counts/cm² h, such that the glass is suitable for radiation-sensitive sensors.

1. Low-radiation cover glass for radiation-sensitive sensors, specifically for semiconductor technology, with low intrinsic a radiation, with a glass composition selected from aluminosilicate glass, aluminoborosilicate glass, borosilicate glass, in particular borosilicate glass that is devoid of alkali, with a TiO₂ content in the range of >0.1-10% by weight, in particular 1-8% by weight.

2. Low-radiation cover glass according to claim 1,
characterized by having
a titanium content in the range of 1.5 to 7% by weight, preferably 2 to 6% by
weight, most preferably 3-5% by weight.

3. Low-radiation cover glass according to claim 1 or 2,
characterized by having
an α radiation level in the cover glass of <0.0020 counts/cm² h, preferably <0.0015 counts/cm² h, most preferably <0.0013 counts/cm² h.

4. Low-radiation cover glass according to at least one of the preceding claims 1 to 3,
characterized by having
a γ radiation level of <2.00 Bq/g, preferably <1.67 Bq/g.

5. Low-radiation cover glass according to at least one of the preceding claims 1 to 4,
characterized by having
a glass composition with a K₂O content of 0-20% by weight, specifically >5-8% by weight.

6. Low-radiation cover glass according to at least one of claims 1 to 5,
characterized by
a glass composition that is selected from one of the following (% by weight on an oxide basis):

| | |
|---|---|
| SiO₂ | 60-70% by weight |
| Na₂O | 1-10% by weight |
| K₂O | 0-20% by weight, specifically >5 to 8% by weight |
| ZnO | 0-10% by weight |
| Al₂O₃ | 0-10% by weight |
| B₂O₃ | 0-10% by weight |
| TiO₂ | >0.1-10% by weight, specifically 1 to 8% by weight |
| Sb₂O₃ | 0-2% by weight |

7. Low-radiation cover glass according to at least one of claims 1 to 5,
characterized by
a glass composition that is selected from at least one of the following (% by weight on an oxide basis):

| | |
|---|---|
| SiO₂ | 48-58% by weight |
| BaO | 10-30% by weight |
| B₂O₃ | 1-15% by weight |
| Al₂O₃ | 0-20% by weight |
| As₂O₃ | 0-2% by weight |
| SrO | 0-3% by weight |
| CaO | 0-5% by weight |

where 1 to 2% by weight of BaO are substituted by TiO₂.

8. Low-radiation cover glass according to claim 7,
characterized by having
a glass composition with a TiO₂ content of 0.1-10% by weight, specifically 1 to 6% by weight.

9. Low-radiation cover glass according to claim 7,
characterized by having
no or essentially no radium in the BaO used.

10. Low-radiation cover glass according to at least one of claims 1 to 5,
characterized by
a glass composition that is selected from one of the following (% by weight on an oxide basis):

| | |
|---|---|
| SiO₂ | 45-70% by weight, specifically 60 to 70% by weight |
| B₂O₃ | 1-20% by weight, specifically 10 to 15% by weight |
| Al₂O₃ | 0-20% by weight, specifically 5 to 10% by weight |
| Na₂O | 1-10% by weight, specifically 1 to 5% by weight |
| BaO | 1-10% by weight, specifically 5 to 10% by weight |
| ZnO | 1-5% by weight, specifically 1 to 2% by weight |
| As₂O₃ | 0-2% by weight, specifically 0.1 to 1% by weight |
| TiO₂ | 1-5% by weight, specifically 1 to 2% by weight |

11. Low-radiation cover glass according to at least one of the preceding claims 1 to 10,
characterized by having
a uranium and thorium content in the cover glass in each case <20 ppb, preferably <15 ppb, most preferably <10 ppb.

12. Low-radiation cover glass according to at least one of the preceding claims 1 to 11,
characterized by having
a radium content in the cover glass in each case <20 ppb, preferably <15 ppb, most preferably <10 ppb.

13. Low-radiation cover glass according to at least one of claims 1 to 12,
characterized by having
the glass essentially devoid of potassium, preferably essentially devoid of alkali.

14. Low-radiation cover glass according to at least one of the preceding claims 1 to 13,
characterized by having
a thickness of the low-radiation cover glass of 0.03 to 20 mm, specifically of 0.1 to 5 mm.

15. The use of low-radiation cover glass according to at least one of the preceding claims 1 to 14 in the area of semiconductor technology, specifically for radiation-sensitive sensors.
